(19) United States
(12) Patent Application Publication
(10) Pub. No.: US 2017/0017861 A1
(43) Pub. Date: Jan. 19, 2017

(54) METHODS AND SYSTEMS FOR RECOMMENDING CONTENT

(71) Applicant: XEROX CORPORATION, Norwalk, CT (US)

(72) Inventors: Sonal S. Patil, Dhule (IN); Kundan Shrivastava, Bangalore (IN); Om D. Deshmukh, Bangalore (IN)

(21) Appl. No.: 14/802,089

(22) Filed: Jul. 17, 2015

(51) Int. Cl. G06K 9/62; G06F 17/27; G06F 17/28; G06K 9/18; G06K 9/46

(52) U.S. Cl. CPC G06K 9/6201; G06K 9/18; G06K 9/46; G06F 17/28; G06F 17/2785

(57) ABSTRACT

The disclosed embodiments relate to a method for content recommendation. The method includes determining, by one or more processors, one or more features of a segment of a first content being accessed during a presentation of the first content on a user-computing device. The segment of the first content is accessed for a predetermined number of times. The method further includes extracting for a feature from the one or more features, a second content based on the feature, wherein the second content is recommended through the user-computing device.

### TECHNICAL FIELD

The presently disclosed embodiments are related, in general, to content delivery systems. More particularly, the presently disclosed embodiments are related to methods and systems for recommending content to a user.

### BACKGROUND

With the advancements in communication technology and processing capabilities of computing devices, a large number of users have access to online content. Such online content may be accessed through various online sources such as, but not limited to, file transferring portals, online data repositories, streaming server, search engines, meta search portals, online archives, online encyclopedias, and the like.

Usually online sources, hosting the online content, may recommend content that may be of interest to the user. Typically, the online sources may track user activities on the respective websites to determine user preferences. An example of the user activity may include searching for the content on the online source. Thereafter, based on the user preferences, the online sources may recommend the content to the user.

### SUMMARY

According to embodiments illustrated herein, there is provided a method for content recommendation. The method includes determining, by one or more processors, one or more features of a segment of a first content being accessed during a presentation of the first content on a user-computing device. The segment of the first content is accessed for a predetermined number of times. The method further includes extracting for a feature from the one or more features, a second content based on the feature, wherein the second content is recommended through the user-computing device.

According to embodiments illustrated herein there is provided a system for content recommendation. The system includes one or more processors configured to determine one or more features of a segment of a first content being accessed during a presentation of the first content on a user-computing device. The segment of the first content is accessed for a predetermined number of times. The one or more processors are further configured to extract, for a feature from the one or more features, a second content based on the feature, wherein the second content is recommended through the user-computing device.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram illustrating a system environment in which various embodiments may be implemented;

FIG. 2 is a message flow diagram illustrating flow of message/data between various components of the system environment, in accordance with at least one embodiment;

FIG. 3 is a block diagram of the user-computing device, in accordance with at least one embodiment;

FIG. 4 is a snapshot of a user interface illustrating a content player that is configured to present the first content on the user-computing device, in accordance with at least one embodiment;

FIG. 5 is a snapshot of a user interface illustrating a software application that is configured to present the first content on the user-computing device, in accordance with at least one embodiment;

FIG. 6 is a block diagram of the content server, in accordance with at least one embodiment;

FIG. 7 illustrates a snapshot of a user interface illustrating recommendation of the one or more second content items, in accordance with at least one embodiment;

FIG. 8 is a flowchart illustrating a method for determining a navigation pattern of a user, in accordance with at least one embodiment;

FIG. 9 is flowchart illustrating a method for determining a navigation pattern based on one or more inputs received from the user of the user-computing device, in accordance with at least one embodiment;

FIG. 10 is a flowchart illustrating a method for recommending one or more second content, in accordance with at least one embodiment;

FIG. 11 is a flowchart illustrating a method for determining one or more features, in accordance with at least one embodiment; and

FIG. 12 is a flowchart illustrating a method for determining one or more features from the segment of the first content, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “multimedia content” refers to at least one of, but not limited to, audio, video, text, image, or animation. In an embodiment, the multimedia content may be played through a media player such as VLC Media Player, Windows Media Player, Adobe Flash Player, Apple QuickTime Player, etc., on a computing device. In an embodiment, the multimedia content may be downloaded or streamed from a content server to the computing device. In an alternate embodiment, the multimedia content may be stored on a media storage device such as Hard Disk Drive, CD Drive, Pen Drive, etc., connected to (or inbuilt within) the computing device.

A “frame” refers to a portion or a snippet of a multimedia content. In an embodiment, the frame may correspond to a snapshot of the multimedia content at a particular time instance. In an embodiment, the frame may be encoded in accordance to one or more encoding algorithms such as, but not limited to, MPEG4, AVI, etc.

A “human object” refers to an individual captured within a multimedia content. A person skilled in the art will understand that the human object may also include one or more of, but not limited to, an animated character, a cartoon character, or any other fictitious animated character in the multimedia content. In an embodiment, the human object may remain active in the multimedia content. In an embodiment, the human object may interact with an inanimate object in the multimedia content by performing one or more actions on the inanimate object.

An “inanimate object” refers to any object other than a human object, captured in a set of frames of a multimedia content. In an embodiment, the inanimate object may remain passive in the multimedia content. In an embodiment, the inanimate object may include, but is not limited to, a presentation slide, a writing board, a poster, a paper, or a prop/model.

An “interaction” refers to an action performed by a human object on an inanimate object in the multimedia content. In an embodiment, examples of the action performed by the human object on the inanimate object include, but are not limited to, the human object writing on the inanimate object, the human object pointing towards or touching the inanimate object, the human object holding the inanimate object, the human object scrolling through a textual content on the inanimate object, or the human object modifying/highlighting the textual content on the inanimate object.

“Content” may correspond to a piece of information that may be of interest to a user. In an embodiment, the content may correspond to a multimedia content or a text content.

A “content player” refers to a software application that may be utilized to present content on a computing device. In an embodiment, the content player may be configured to present a multimedia content. In another embodiment, the content player may be configured to present the text content to the user. In an embodiment, the content player may include a navigation axis that may represent a duration of the multimedia content. Further, the navigation axis include a seek bar that is used for representing a current playback position of the content. In an embodiment, the current playback position may represent a timestamp of the display of the first content.

A “body language” refers to a non-verbal message, a feeling, a thought, or an intention conveyed by a human object in the multimedia content. In an embodiment, the body language may be determined based on one or more of, but not limited to, a hand motion of the human object in the multimedia content, a body motion of the human object, a facial expression/emotion of the human object, a proximity of the human object to a video capturing device utilized for creation of the multimedia content, or an eye contact of the human object towards the video capturing device.

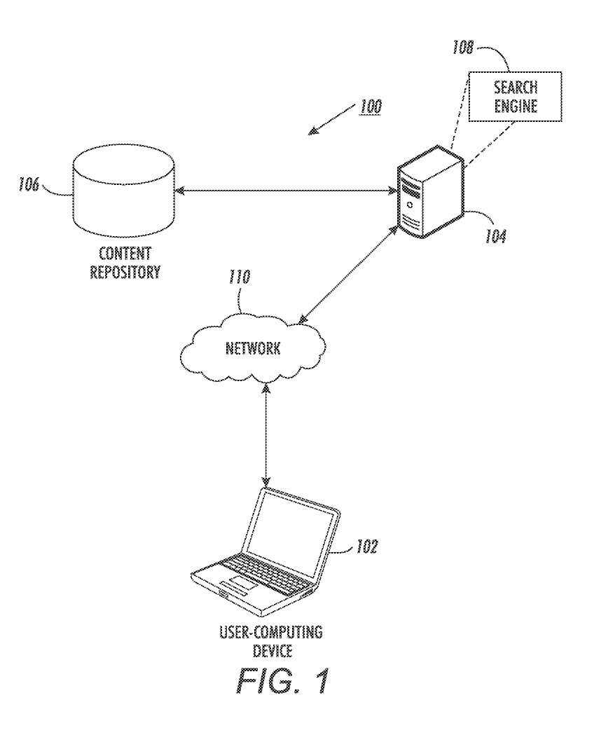

FIG. 1 is a block diagram illustrating a system environment 100 in which various embodiments may be implemented. The system environment 100 includes a user-computing device 102, a content server 104, and a content repository database 106. The content server 104 may further comprise a search engine 108.

The content server 104 is connected to the user-computing device 102 through a network 110. Further, the content server 104 is further connected to the content repository database 106.

The user-computing device 102 comprises one or more processor, one or more memories, input devices (such as, but not limited to, keyboard and mouse), display devices (such as, but not limited to, display screen and projectors). The one or more processors 202 may control the functionalities of the input devices, the display devices, and the one or more memories, based on the instructions stored in the one or more memories. Further, the one or more processors may perform predetermined operations on the user-computing device 102 based on the instructions stored in the one or more memories. A user of the user-computing device 102 may utilize the input devices to provide input or instructions for the one or more processors 202 to process. For instance, the user may provide input through the input devices to access a first content hosted by the content server 104. The user-computing device 102, on receiving the input from the user, may retrieve the first content from the content server 104. In an embodiment, the one or more processors of the user-computing device 102 may then present the first content on the display devices through a content player. A person having ordinary skill in the art would understand that the scope of the disclosure is not limited to utilizing the content player to display the first content. In an embodiment, any software application that has the capability to present the first content on the display devices or any other output device may be used. In an embodiment, the software application being used to present the first content may vary based on the type of the first content to be presented on user-computing device 102. For example, if the first content corresponds to a multimedia content, the content player may be used to present the first content. In another example, if the first content corresponds to a document, a document processor software may be used to present the first content.

The user-computing device 102 may receive inputs from the user corresponding to navigation through the first content. The one or more processors may track the navigation pattern of the user on the first content. Based on the navigation pattern, the one or more processors may determine a segment of the first content that is frequently accessed by the user during the presentation of the first content. The user-computing device 102 may transmit the segment of the first content to the content server 104. In another embodiment, the user-computing device 102 may transmit the navigation pattern to the content server 104. The user-computing device 102 may include a variety of computing devices such as, but not limited to, a laptop, a personal digital assistant (PDA), a tablet computer, a smartphone, a phablet, and the like.

The content server 104 refers to a computing device that is configured to maintain a repository of content. The content server 104 may include one or more processors and one or more memories. The one or more memories may include one or more instructions executable by the one or more processors to perform predetermined operations. The content server 104 includes the content repository database 106 and the search engine 108. The content server 104 utilizes the content repository database 106 to store one or more content items. In an embodiment, the content server 104 may index the one or more content items based on the one or more features of each of the one or more content items. The content server 104 may further utilize the search engine 108 to search through the one or more content items in the content repository database 106. In an embodiment, the content server 104 may utilize the one or more features or one or more keywords as search strings/query to search through the one or more content items in the content repository database 106.

In an embodiment, the content server 104 may further host a web application, which may accessed by the user-computing device 102. In an embodiment, the web application may act as an interface for the user-computing device 102 to access the one or more content items. The web application may include a search interface that may be used by the user of the user-computing device 102 to input one or more search queries in order to retrieve the first content. In an embodiment, the content server 104 may utilize the one or more search queries (received from the user) to retrieve the first content.

The content server 104 may receive the segment of the first content from the user-computing device 102. Thereafter, the content server 104 may determine one or more features of the segment of the first content. The content server 104 may utilize the one or more features as the search string, to retrieve one or more second content from the content repository database 106. The one or more second content are recommended to the user through the user-computing device 102.

In a scenario, where the content server 104 receives the navigation pattern from the user-computing device 102, the content server 104 may extract the segment of the first content based on the navigation pattern. Thereafter, the content server 104 performs steps mentioned above to recommend one or more second content.

The content server 104 may be realized through various types of content servers such as, but not limited to, Adobe Content Server, Oracle Content Server, or any other content server framework.

The content repository database 106 refers to a database of the one or more content items. In an embodiment, the one or more content items may be indexed based on the respective one or more features associated with each of the one or more content items. The one or more content items in the content repository database 106 may be accessed through the search engine 108 using one or more keywords or the one or more features, as the search strings. For querying the content repository database 106, one or more querying languages, such as, but not limited to, SQL, QUEL, DMX, and so forth, may be utilized. Further, the content repository database 106 may be realized through various technologies such as, but not limited to, Microsoft® SQL Server, Oracle®, IBM DB2®, Microsoft Access®, PostgreSQL®, MySQL® and SQLite®, and the like. In an embodiment, the content repository database 106 may connect to the content server 104, using one or more protocols such as, but not limited to, ODBC protocol and JDBC protocol.

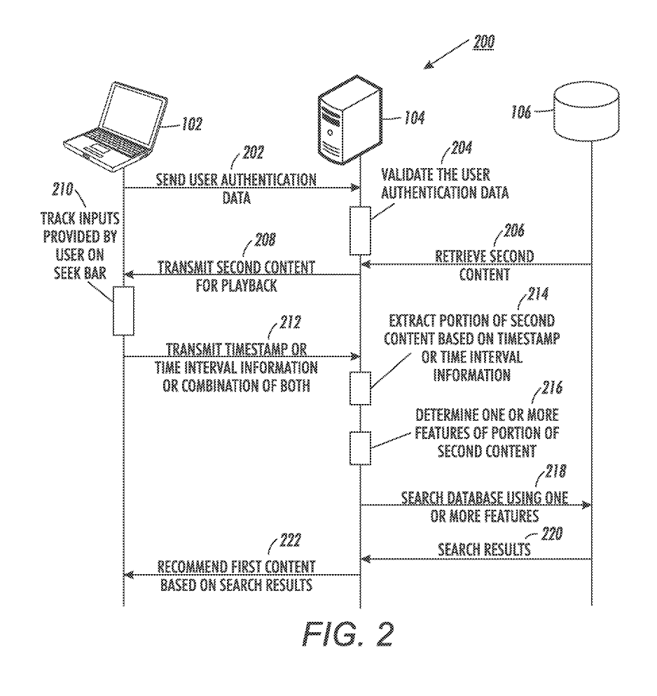

FIG. 2 is a message flow diagram 200 illustrating a flow of message/data between various components of the system environment, in accordance with at least one embodiment. The message flow diagram 200 has been described in conjunction with FIG. 1.

The user-computing device 102 transmits a user authentication data to the content server 104 (depicted by 202). The content server 104 may validate the user authentication data to check if the user is legit (depicted by 204). If the content server 104 determines that the user is legit, the content server 104 transmits a notification to the user-computing device 102 (depicted by 206). Thereafter, the user-computing device 102 may transmit a query, to the content server 104, to retrieve the first content (depicted by 208). The content server 104 may utilize the query to search for the first content (using the search engine 108) in the content repository database 106 (depicted by 210). If the first content is identified, the content server 104 may first retrieve and then transmit the first content to the user-computing device (depicted by 212).

In an embodiment, if the first content corresponds to a multimedia content, the content server 104 may transmit the first content to user-computing device 102 using one or more streaming protocols such as, but are not limited to, Real-time Streaming Protocol (RTSP), Peer to Peer protocols (P2P), UDP, and TCP/IP protocol. In another embodiment, if the first content corresponds to text content, the content server 104 may utilize protocols such as, but are not limited to, Hypertext Transfer Protocol (HTTP), and file transfer protocol (FTP), to transmit the first content to the user-computing device 102.

On receiving the first content, the user-computing device 102 may present the first content to the user through the display devices or any other output devices (depicted by 214). In an embodiment, the user-computing device 102 may utilize suitable software applications to present the first content on the user-computing device 102. For example, if the first content corresponds to the multimedia content, the user-computing device 102 may utilize a multimedia player to display the first content to the user. Some know multimedia players may include, but not limited to, Windows Media Player, VLC player, Quick Time Player, and the like. Further, if the multimedia content is being displayed through the web browser, the user-computing device 102 may utilize content players such as Adobe Flash player, Adobe shockwave player, and HTML5 multimedia player to display the first content. In an alternate embodiment, if the first content corresponds to a text content, the user-computing device 102 may utilize software applications such as a word processor, a notepad, or any other software application that has the capability to display the text content.

During display of the first content, the user-computing device 102 may track the inputs provided by the user on the first content (depicted by 216). In an embodiment, the inputs may include, but are not limited to, scrolling through the first content using seek bar, highlighting a segment of the first content (if the first content corresponds to the text content). Based on the inputs provided by the user, the user-computing device 102 may determine the navigation pattern. The user-computing device 102 may transmit the navigation pattern to the content server 104 (depicted by 218). The content server 104 may extract the segment of the first content from the first content based on the navigation pattern (depicted by 220). Thereafter, the content server 104 may determine the one or more features of the segment of the first content (depicted by 222).

The content server 104 utilizes the one or more features as the search query to search for the one or more second content in the content repository database 106 (depicted by 224). The content server 104 receives a list of the one or more second content items from the content repository database 106 based on the search query (depicted by 226). The content server 104 may transmit the list of the one or more second content as recommendation to the user-computing device 102 (depicted by 228).

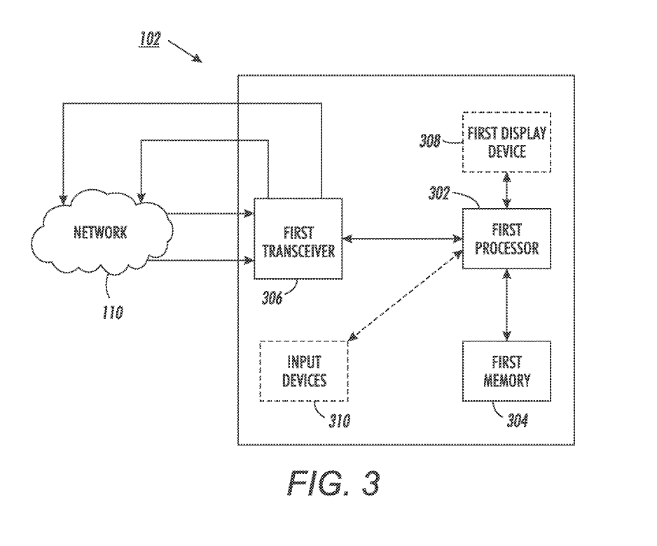

FIG. 3 is a block diagram of the user-computing device 102, in accordance with at least one embodiment. The user-computing device 102 comprises a first processor 302, a first memory 304, a first transceiver 306, a first display device 308, and input devices 310.

The first processor 302 includes suitable logic, circuitry, and/or interfaces that are operable to execute one or more instructions stored in the first memory 304 to perform pre-determined operation. The first memory 304 may be operable to store the one or more instructions. The first processor 302 may be implemented using one or more processor technologies known in the art. Examples of the first processor 302 include, but are not limited to, an x86 processor, a RISC processor, an ASIC processor, a CISC processor, or any other processor.

The first memory 304 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the first memory 304 includes the one or more instructions that are executable by the first processor 302 to perform specific operations. It will be apparent to a person having ordinary skill in the art that the one or more instructions stored in the first memory 304 enables the hardware of the user-computing device 102 to perform the predetermined operation.

The first transceiver 306 transmits and receives messages and data to/from various components of the system environment 100 over the network 110. Examples of the first transceiver 306 may include, but are not limited to, an antenna, an Ethernet port, a USB port, or any other port that can be configured to receive and transmit data. The first transceiver 306 transmits and receives data/messages in accordance with the various communication protocols such as, TCP/IP, UDP, and 2G, 3G, or 4G communication protocols.

The first display device 308 may comprise suitable logic, circuitry, interfaces, and/or code that may be operable to render a display. In an embodiment, the first display device 308 may be realized through several known technologies such as, Cathode Ray Tube (CRT) based display, Liquid Crystal Display (LCD), Light Emitting Diode (LED) based display, Organic LED display technology, and Retina display technology. In addition, in an embodiment, the first display device 308 may be capable of receiving input from the user. In such a scenario, the first display device 308 may be a touch screen that enables the user to provide an input. In an embodiment, the touch screen may correspond to at least one of a resistive touch screen, capacitive touch screen, or a thermal touch screen. In an embodiment, the first display device 308 may receive input through a virtual keypad, a stylus, a gesture, and/or touch based input.

The input devices 310 may comprise suitable logic, circuitry, interfaces, and/or code that may be operable to receive an input from the user. The input devices 310 may be operable to communicate with the first processor 302. Examples of the input devices 310 may include, but are not limited to, a keyboard, a touch screen, a microphone, a camera, a motion sensor, a light sensor, and/or a docking station.

In operation, the user of the user-computing device 102 utilizes the input devices 310 to provide input to access the web application hosted by the content server 104. The first processor 302 may send the request to access the web application to the content server 104. In an embodiment, the request may include user authentication details of the user. The first processor 302 may receive the data pertaining to the web application from the content server 104, when the authentication details are legit. Thereafter, the first processor 302 may instruct the first display device 308 to display the web application based on the received data. In order to display the web application, the first processor 302 may execute a web browser application. In an embodiment, the web browser application may have the capability to render the data pertaining to the web application on the first display device 308.

In an embodiment, the web application may have a search interface that enables the user to input one or more search queries to search through the one or more content items hosted by the content server 104. In an embodiment, the user may provide an input pertaining to a search query in the search interface on the web application using the input devices 310. The first processor 302 is configured to transmit the search query to the content server 104 through the first transceiver 306.

In response to the search query, the first processor 302 may receive a list of content items from the content server 104. The first processor 302 may instruct the first display device 308 to display the list of content items through the web application. In an embodiment, the user may provide an input using the input devices 310 to select at least one content item from the list of content items. The first processor 302 may transmit the information pertaining to the selection of the at least one content item to the content server 104. Hereinafter, the at least one content item (initially selected by the user) has been replaceably referred to as the first content.

Thereafter, the first processor 302 may receive the first content from the content server 104 through the first transceiver 306. The first processor 302 may invoke/trigger a software application to present the first content received from the content server 104. In an embodiment, the software application may correspond to a web browser plugin that may enable the presentation of the first content through the web application itself. For example, the first content correspond to a multimedia content. In such a scenario, the first processor 302 may trigger a video player plugin such as Adobe Flash player plugin to present the first content on the first display device 308 in the web browser. A person having ordinary skill in the art would understand that the scope of the disclosure is not limited to Adobe flash player being used to present the first content. In an embodiment, various other plugins such as, but are not limited to, Windows media player plugin, Quick time plugin, and html 5 based content player, may be used by the first processor 302 to present the first content on the first display device 308.

A person having ordinary skill in the art would understand that a typical content player includes a predefined area, where the first content is displayed on the first display device 308. Further, the content player includes a playback axis that is used to depict the duration of display of the first content. In an embodiment, the playback axis may further comprise a seek bar or navigation bar that moves along the navigation axis and may be used to depict the current playback position of the first content. For example, the first content corresponds to a two-hour long video. Therefore, the playback axis will depict a timeline starting from 0 and ending at 120 minutes. The seek bar on the playback axis depicts the current position of the playback of the multimedia content. For example, the seek bar is at position representing a timestamp of 30 minutes on the playback axis, therefore the segment of the multimedia content at 30 minutes is being displayed on the content player. Hereinafter, the current position of the seek bar has been replaceably referred to as original playback position.

In an alternate embodiment, where the first content corresponds to a text content, the first processor 302 may trigger a software application that may have the capability to display the text content on the first display device 308. In an embodiment, such software applications may have a web browser plugin that may enable viewing of the first content in the web browser itself. Example of such software application include, but are not limited to, Adobe reader, Word processor, and Power point application.

A person having ordinary skill in the art would understand that the user interface of the software application used to display the text content, may include a portion where the text content may be displayed on the first display device 308. Further, the software application may further display a scroll bar and a slider on the scroll bar. In an embodiment, the scroll bar may be deterministic of the length or size of the first content. Further, the slider of the scroll bar may be used to scroll through the first content. For example, the first content received from the content server 104 is a ten page long document. Displaying ten pages, simultaneously, on the display device in a manner that content in the ten pages is readable by the user is not possible. Therefore, the first processor 302 may only display a portion of the first content on the first display device 308 at any given moment of time. The remaining portion of the first content may be accessed by moving the slider along the scroll bar.

During the display of the first content, the first processor 302 is further configured to track the input received from the user through the input devices 310. In an embodiment, the inputs provided by the user may correspond to one or more actions performed by the user during the display of the first content. The different types of actions performed by the user has been explained based on the type of the first content being displayed on the first display device 308.

### Multimedia Content

In an embodiment, the multimedia content, displayed on the first display device 308, is usually a time based content. In an embodiment, the time based content corresponds to content that are of predetermined time duration. During the playback of the multimedia content, the user may want to view a segment of the multimedia content that may chronologically precede or succeed the current playback position of the multimedia content. In order to view the segment of the multimedia content, the user may provide the input to move the seek bar along the playback axis to access the segment of the multimedia content.

For example, the multimedia content corresponds to an educational video. Let the educational video be an hour video in which the presenter has explained a first concept in order to explain a second concept. For the purpose of the ongoing example, the current position of the display of the multimedia content is such that the presenter in the content is explaining the second concept. The user is not clear on the first concept, and hence is not able to understand the second concept being explained in the multimedia content. Therefore, the user may provide an input using the input devices 310 to move the seek bar to an approximate position where the user believes that the presenter has explained the first concept in the first content. As the exact position of the seek bar (corresponding to the first concept in the first content) may be unknown to the user, the user may move the seek bar, along the playback axis, in a hit and trail fashion to get to an exact position where the first concept has been explained in the first content. In an embodiment, the user may have to move the seek bar multiple number of times in order to identify the exact position. The first processor 302 may be operable to track such inputs provided by the user to determine the navigation pattern.

In an embodiment, the first processor 302 may determine a number of times a user has provided the input pertaining to moving of the seek bar around same position or a first timestamp (deterministic from the position of the seek bar) associated with the first content. The first processor 302 may compare the first timestamp of the seek bar, to which the seek bar has been moved by the user, with all the timestamps to which the seek bar was previously moved during the display of the first content. Thereafter, the first processor 302 may compare the difference between the first timestamp and each of the timestamps, with a first threshold. Based on the comparison, the first processor 302 may determine the number of times the user has provided input to move the seek bar. For example, the current playback position of the first content is 6.47. The user moves the seek bar to a position representing a timestamp 3.97. Thereafter, the user provides an input to move the seek bar at the position representing a timestamp 4.45. The first processor 302 compares the position 4.45 with 3.97 to determine that the two timestamps are 0.48 seconds apart. The first processor 302 compares the difference between the two timestamps with the first threshold value. If the difference is less than the first threshold value, the first processor 302 counts the first movement (to a position 3.97) and the second movement (to a position 4.45), as inputs provided by the user. On the other hand if the difference between the two timestamps is greater than the first threshold value, the first processor 302 does not consider the first movement (to a position 3.97) and the second movement (to a position 4.45), as inputs provided by the user.

In an embodiment, the comparison with the first threshold ensures that only those inputs, corresponding to movement of the seek bar, which are near to each other with respect to their time stamps, are counted as the inputs provided by the user. After determining the count of the inputs, the first processor 302 compares the count of the inputs with a second threshold value. If the count of the inputs exceeds the second threshold, the first processor 302 selects the timestamps, corresponding to the positions of the seek bar (to which it was moved), as a navigation pattern.

In an alternate embodiment, the first processor 302 is configured to determine a minima of the first timestamps (to which the seek bar was moved by the user), in the navigation pattern. In an embodiment, the first processor 302 considers the minimum of the first timestamps as the starting timestamp of the segment of the first content.

In an embodiment, the first processor 302 may further track a second timestamp after which the user may provide input through the input devices 310 to move the seek bar to the current playback position (i.e., the original playback position of the first content, from which the user provided input to move the seek bar). In an embodiment, the first processor 302 may include the second timestamp in the navigation pattern. As the user may access the segment of the first content multiple times, therefore there may be multiple instances where the user provides input to move the seek bar from the second timestamp position to the current playback position. A person having ordinary skill in the art would understand that it may not be necessary that the second timestamp is same every time the user access the segment of the first content. Therefore, the first processor 302 may include every instance of the second timestamp in the navigation pattern.

In an embodiment, the first processor 302 may further determine an average of all the instances of the second timestamp to determine an average second timestamp. In an embodiment, the first processor 302 may consider the average second timestamp is as the end timestamp of the segment of the first content.

### Text Content

Usually, the text content is displayed through one or more software applications. If the text content is large, the text is displayed in one or more pages. A user going through the text content may want to access/read content written in the previous pages. In such a scenario, the user may use the scroll bar in the software application to scroll back and forth through the text content in order to refer to the content written in the previous pages. The first processor 302 may track such navigation through the text content. For example, the user is reading the 100^{th} page of the electronic document. While reading the electronic document, the user wants to refer to a concept previously explained in the electronic document. Therefore, the user may scroll through previous pages of the electronic document to refer to the concept.

In alternate embodiment, the user may utilize the search option, provided in the software application, to search for the concept in the electronic document. The user may provide input pertaining to one or more keywords through the input devices 310. The first processor 302 may search for the one or more keywords in the electronic document. If the one or more keywords are identified in the electronic document, the first processor 302 may display the page on which the one or more keywords are present.

Further, in an embodiment, the user may use the input devices 310 to highlight a portion of the text content, while reading through the text content.

In an embodiment, the first processor 302 may consider the searching through the text content, scrolling through the text content, and highlighting the text content, as the one or more actions performed by the user. In an embodiment, the one or more actions performed by the user on the text content corresponds to the navigation pattern.

A person having ordinary skill in the art would understand that the scope of the disclosure is not limited to in-content tracking (i.e., tracking of the user inputs within the content that is being presented on the user-computing device) of the user inputs. In an embodiment, the first processor 302 may be configured to track user inputs on other applications that being executed by the user-computing device 102 during the presentation of the first content. For example, during the presentation of the multimedia content on a browser, the user provides input, through the input devices 310, to open another instance of the browser. Through another instance of the browser, the user may search for the second concept being discussed in the multimedia content. The first processor 302 may track such user inputs to determine the navigation pattern. Further, person having ordinary skill in the art would understand that the scope of the disclosure is not limited to searching for the concept on another browser instance. In an embodiment, the user may refer to a text file describing the second concept during the presentation of the multimedia content.

After the determination of the navigation pattern, the first processor 302 may transmit the navigation pattern to the content server 104 through the first transceiver 306 over the network 110.

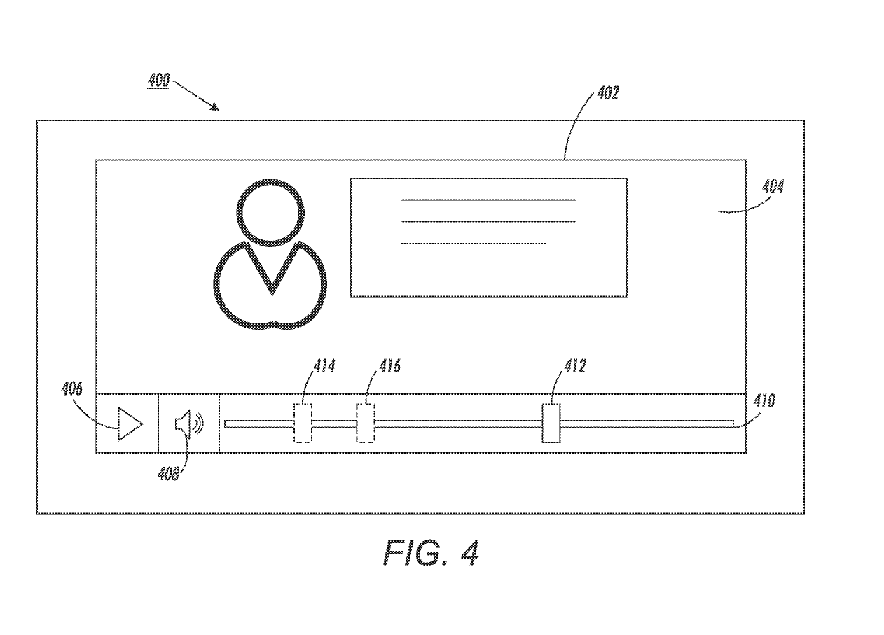

FIG. 4 is a snapshot of a user interface 400 illustrating a content player 402 that is configured to present the first content on the user-computing device 102, in accordance with at least one embodiment. The content player 402 has been described in conjunction with FIG. 3.

The content player 402 comprises a content display portion 404, a first button 406, a second button 408, a playback axis 410, a seek bar 412.

The content display portion 404 is configured to present a video portion of the first content on the user-computing device 102. In a scenario, where the first content does not contain the video portion, the content display portion 404 may display a predetermine image. In an embodiment, the predetermined image may correspond to a thumbnail of the first content. If the thumbnail of the first content is not available, the content display portion 404 may just display a predetermined icon.

The first button 406 enables the user to control the playback of the first content on the content player 402. In an embodiment, the first button 406 may enable the user to ‘play’, ‘pause’, or ‘stop’ the playback of the first content. In an embodiment, the user may utilize the input devices 310 (e.g., mouse) to click on the first button 406 in order to control the playback of the first content on the content player 402.

The second button 408 enables the user to control the playback of the audio portion associated with the first content. In an embodiment, user may use the second button 408 to mute/unmute the audio playback. Further, the user may control the volume of the playback of the audio content using the second button 408.

The playback axis 410 depicts the duration of presentation of the first content on the content player 402. The playback axis 410 further comprise the seek bar 412. The seek bar 412 slides over the playback axis 410 and depicts current playback position of the first content. Further, the user of the user-computing device 102 may provide inputs to drag the seek bar 412 along the playback axis 410 to access a specific segment of the first content. For example, the user may provide the input to drag the seek bar 412 to position 414 in order to access the segment of the first content, starting from the position 414. Similarly, the user may provide the input to drag the seek bar 412 to position 416 in order to access the segment of the first content, starting from the position 416.

A person having ordinary skill in the art would understand that the position of the seek bar 412 is representative of the timestamp of the presentation of the first content. However, the scope of the disclosure is not limited to the seek bar 412 being representative of the timestamp of the presentation of the first content. In an embodiment, the seek bar 412 may represent a frame of the first content.

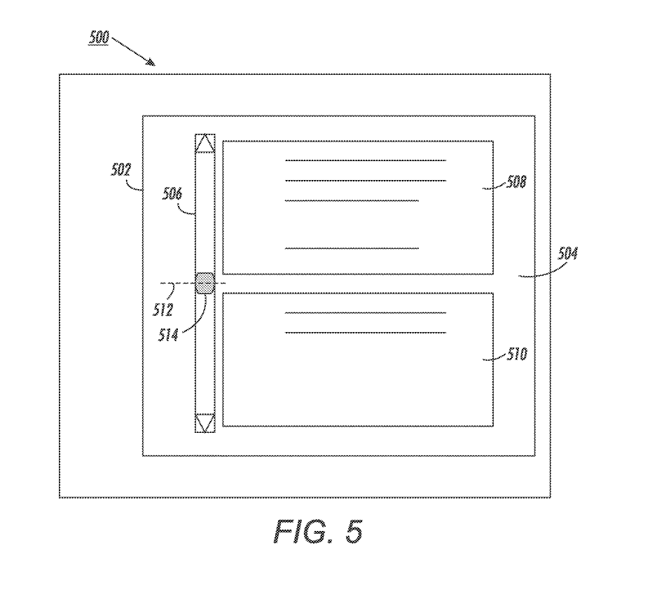

FIG. 5 is a snapshot of a user interface 500 illustrating a software application 502 that is configured to present the first content on the user-computing device 102, in accordance with at least one embodiment.

The user interface 500 of the software application 502 comprises a content display portion 504, a scroll bar 506, and a slider 514 on the scroll bar.

The content display portion 504 is configured to present the text content on the user-computing device 102. A person having ordinary skill in the art would understand that the text content may be large in size and thus adjusting the text content in a single page may not be possible. Therefore, in such a scenario, the software application 502 may display the text content in one or more pages. For example, referring to FIG. 5, the text content is adjusted in a first page 508 and a second page 510. A person having ordinary skill in the art would understand that the scope of the disclosure is not limited to displaying the text content only in two pages. In an embodiment, the software application 502 may display the text content in multiple pages depending on the size of the text content.

Further, the software application 502 comprises a scroll bar 506. The scroll bar 506 may have the slider 514 that may slide vertically to scroll through the one or more pages of the text content. Further, the user of the user-computing device 102 may provide inputs to move the slider 514 on the scroll bar. For example, the user may provide the input to move the slider 512 to position 512 in order to access the seventh page of the text content. A person having ordinary skill in the art would understand that the scope of the disclosure is not limited to the scroll bar 506 sliding vertically. In an embodiment, the scroll bar 506 may further slide in a horizontal direction without departing from the scope of the disclosure.

Further, the user interface 500 of the software application 502 may include one or more buttons (not shown) that may enable the user of the user-computing device 102 to perform one or more actions such as highlighting a portion of text content and searching for a phrase in the text content.

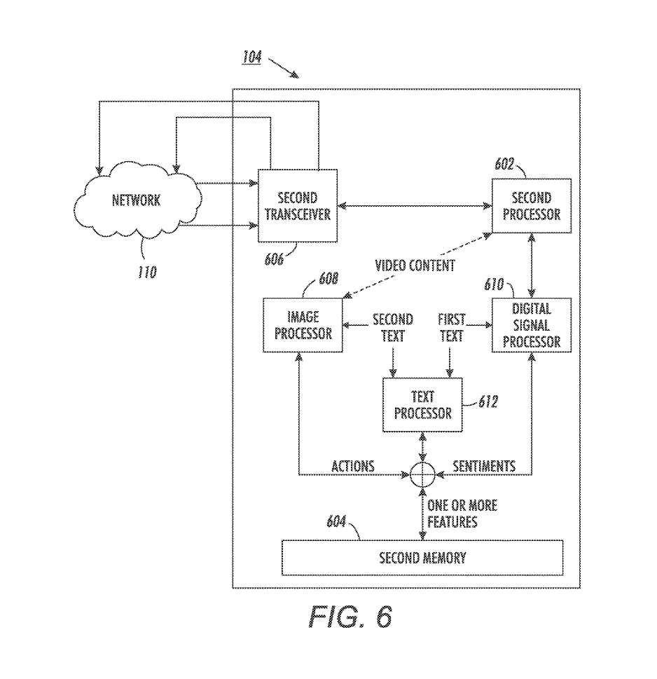

FIG. 6 is a block diagram of the content server 104, in accordance with at least one embodiment. The content server 104 has been described in conjunction with FIG. 1, FIG. 2, and FIG. 3.

The content server 104 includes a second processor 602, a second memory 604, a second transceiver 606, an image processor 608, a digital signal processor 610, and a text processor 612.

The second processor 602 includes suitable logic, circuitry, and/or interfaces that are operable to execute one or more instructions stored in the second processor 602 to perform pre-determined operation. The second memory 604 may be operable to store the one or more instructions. The second processor 602 may be implemented using one or more processor technologies known in the art. Examples of the second processor 602 include, but are not limited to, an x86 processor, a RISC processor, an ASIC processor, a CISC processor, or any other processor.

The second memory 604 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the second memory 604 includes the one or more instructions that are executable by the second processor 602 to perform specific operations. It will be apparent to a person having ordinary skill in the art that the one or more instructions stored in the second memory 604 enables the hardware of the content server 104 to perform the predetermined operation.

The second transceiver 606 transmits and receives messages and data to/from various components of the system environment 100 over the network 110. Examples of the second transceiver 606 may include, but are not limited to, an antenna, an Ethernet port, a USB port, or any other port that can be configured to receive and transmit data. The second transceiver 606 transmits and receives data/messages in accordance with the various communication protocols such as, TCP/IP, UDP, and 2G, 3G, or 4G communication protocols.

The image processor 608 comprises suitable logic, circuitry, and/or interfaces that are operable to execute one or more instructions stored in the second processor 602 to perform pre-determined operation. In an embodiment, the image processor 608 may include one or more electronic circuits and/or gates configured to perform one or more predefined image processing operations. Examples of the one or more predefined image processing operations include, but are not limited to, an image transformation (e.g., conversion of an image from a spatial domain to a frequency domain and vice versa), an image noise reduction, an image thresholding, an image enhancement, and so on. In an embodiment, the image processor 608 may be implemented using the one or more known technologies such as field programmable gate array (FPGA), application specific integrated circuit (ASIC), and system on chip (SoC). Though the image processor 608 is depicted as separate entity from the second processor 602, a person skilled in the art would appreciate that the scope of the disclosure is not limited to realizing the image processor 608 as a separate entity. In an embodiment, the image processor 608 may be implemented within the second processor 602 without departing from the spirit of the disclosure. Further, a person skilled in the art will understand that the scope of the disclosure is not limited to realizing the image processor 608 as a hardware component. In an embodiment, the image processor 608 may be implemented as a software module included in a computer program code (stored in the second memory 604), which may be executable by the second processor 602 to perform the functionalities of the image processor 608.

The digital signal processor 610 is a processor configured to perform one or more audio/speech processing/analysis operations on an audio content within the first content. In an embodiment, the digital signal processor 610 may include one or more electronic circuits and/or gates configured to perform one or more predefined signal-processing operations. Examples of the one or more predefined signal-processing operations include, but are not limited to, a signal transformation (e.g., conversion of a signal from time to frequency domain and vice versa), a noise reduction, a signal filtration, a signal thresholding, a signal attenuation, and so on. In an embodiment, the digital signal processor 610 may be implemented using the one or more known technologies such as field programmable gate array (FPGA), application specific integrated circuit (ASIC), and system on chip (SoC). Though the digital signal processor 610 is depicted as separate entity from the second processor 602, a person skilled in the art would appreciate that the scope of the disclosure is not limited to realizing the digital signal processor 610 as a separate entity. In an embodiment, the digital signal processor 610 may be implemented within the second processor 602 without departing from the spirit of the disclosure. Further, a person skilled in the art will understand that the scope of the disclosure is not limited to realizing the digital signal processor 610 as a hardware component. In an embodiment, the digital signal processor 610 may be implemented as a software module included in a computer program code (stored in the second memory 604), which may be executable by the second processor 602 to perform the functionalities of the digital signal processor 610.

The text processor 612 is a processor configured to analyze natural language content (e.g., textual content within or extracted from the first content) to draw meaningful conclusions therefrom. In an embodiment, the text processor 612 may employ one or more natural language processing and one or more machine learning techniques known in the art to perform the analysis of the text content. Examples of such techniques include, but are not limited to, Naïve Bayes classification, artificial neural networks, Support Vector Machines (SVM), multinomial logistic regression, or Gaussian Mixture Model (GMM) with Maximum Likelihood Estimation (MLE). In an embodiment, the text processor 612 may be implemented using the one or more known technologies such as field programmable gate array (FPGA), application specific integrated circuit (ASIC), and system on chip (SoC). Though the text processor 612 is depicted as separate entity from the second processor 602 in FIG. 2, a person skilled in the art would appreciate that the functionalities of the text processor 612 may be implemented within the second processor 602 without departing from the scope of the disclosure. Further, a person skilled in the art will understand that the scope of the disclosure is not limited to realizing the text processor 612 as a hardware component. In an embodiment, the text processor 612 may be implemented as a software module included in a computer program code (stored in the memory 216), which may be executable by the second processor 602 to perform the functionalities of the text processor 612.

In operation, the second processor 602 may receive a request from the user-computing device 102 to retrieve the first content from the content repository. In an embodiment, the request may include a search query that the second processor 602 may utilize to search in the content repository database 106. In response to the search query, the second processor 602 may receive the first content from the content repository database 106. Thereafter, the second processor 602 may transmit the first content to the user-computing device 102 through the second transceiver 606 over the network 110.

In an embodiment, where the first content corresponds to the multimedia content, the second processor 602 may stream the first content. In an embodiment, the second processor 602 may stream the first content using one or more protocols such as, but are not limited to, real time streaming protocol (RTSP), Real-time Control Protocol (RTCP), and Real data transport (RDT). In an embodiment, the second processor 602 may transmit the first content. In an alternate embodiment, the second processor 602 may transmit the first content as a file using one or more protocols such as, but are not limited to, HTTP, FTP, SSH, and SFTP.

The second processor 602 is further configured to receive the navigation pattern from the user-computing device 102. As discussed above in conjunction with FIG. 3, the navigation pattern is representative of the user actions performed while presentation of the first content on the user-computing device 102. In an embodiment, the one or more actions may include, but are not limited to, navigating to watch a specific segment of the first content, highlighting a portion of the first content, searching for a phrase in the first content, searching for a phrase using a search engine, and watching another content related to concept discussed in the first content.

After receiving the navigation pattern, the second processor 602 may extract a segment of the first content from the first content based on the received navigation pattern. A person having ordinary skill in the art would understand that, as the navigation pattern for different type of first content is different, therefore the extraction of the segment of the first content is also different.

### Multimedia Content

As discussed in conjunction with FIG. 3, that the navigation pattern for the multimedia content includes one or more positions of the seek bar to which the user moved the seek bar in order to access the segment of the first content. Further as discussed above, the navigation pattern may include information of the one or more first timestamp values and the one or more second timestamp values. The one or more first timestamp values may correspond to, one or more positions on the navigations axis, to which the user navigated during the presentation of the first content on the user-computing device. Further, as discussed, the difference of each of the one or more first timestamp values is less than the first threshold value. The second processor 602 may determine the minima of the one or more first threshold values to determine the starting timestamp of the segment. Further, as discussed in conjunction with FIG. 3, the one or more second timestamp values correspond to timestamps from which the user stopped watching the segment of the first content and returned to watch the first content from the original playback position. In an embodiment, the second processor 602 may determine the average second timestamp value based on the one or more second timestamp values. In an embodiment, the second processor 602 may consider the average second timestamp value as the ending timestamp of the segment of the first content.

In a scenario, where the starting timestamp and the ending timestamp is determined by the first processor 302 of the user-computing device 102, the navigation pattern includes the starting timestamp and the ending timestamp. Therefore, in such a scenario, the second processor 602 may not determine the starting timestamp and the ending timestamp.

After determining the starting timestamp and the ending timestamp, the second processor 602 may add a predetermined time duration to the ending timestamp to obtain a modified ending timestamp. Further, the second processor 602 may subtract the predetermine time duration from the starting timestamp to obtain the modified starting timestamp. For example, the starting timestamp and the ending timestamp are 1.43 and 2.30, respectively. Further, let the predetermined time duration is 10 seconds. Therefore, the second processor 602 may add the predetermined time duration of 10 seconds to the ending timestamp to obtain the modified ending timestamp (i.e., 2.40). Similarly, the second processor 602 may subtract the predetermined time duration of 10 seconds from the starting timestamp to obtain the modified starting timestamp (i.e., 1.33).

In an embodiment, the second processor 602 may extract the segment of the first content from the first content based on the modified starting timestamp and the modified ending timestamp. In an embodiment, the second processor 602 may employ any known technique to extract the segment of the first content from the first content.

### Text Content

As discussed in conjunction with FIG. 3, when the first content corresponds to the text content, the navigation pattern includes page numbers (represented by the position of the scroll bar) to which the user navigated during the presentation of the first content. Further, the navigation pattern may include the phrase that the user may have searched in the first content during the presentation of the first content on the user-computing device 102. Additionally, the navigation pattern includes the text phrase highlighted by the user during the presentation of the first content on the user-computing device 102.

In a scenario, where the navigation pattern includes the one or more page numbers, the second processor 602 may extract the one or more pages (having the page numbers) from the text content. In a scenario, where the navigation pattern includes the phrase that was searched in the text content, the second processor 602 may extract the pages that include the phrase. In another scenario, where the navigation pattern includes phrase that was highlighted by the user during the presentation of the first content, the second processor 602 may extract the page containing the highlighted phrase from the first content.

After extracting the segment of the first content, the second processor 602 may determine one or more features of the segment of the first content. The extraction of the one or more features has been described based on the type of the first content (i.e., multimedia content or the text content).

### One or More Features of Multimedia Content

In order to determine the one or more features of the segment of the first content, the second processor 602 may segregate the segment of the first content into a video content and audio content. After extracting the audio content from the segment of the first content, the second processor 602 may transmit the audio content to the digital signal processor 610. Further, the second processor 602 may transmit the video content to the image processor 608.

In an embodiment, the image processor 608 is configured to analyze one or more image frames in the video content to determine body language information of one or more human objects in the video content. In an embodiment, the image processor 608 may determine the body language information based on one or more of a hand motion of the human object in the video content, a body motion of the human object, a facial expression/emotion of the human object, a proximity of the human object to a video capturing device utilized for creation of the video content, or an eye contact of the human object towards the video capturing device.

### Hand Motions of the Human Object

For example, the human object uses frequent hand gestures in the video content. Thus, in such a scenario, the human object may be confident and may display openness in expressing his/her feelings and explaining the one or more concepts in the video content. Further, if the human object keeps his/her hands in a relaxed state, this may be indicative of the human object being in a relaxed state of mind. Thus, it may indicate self-confidence and self-assurance. However, if the human object clenches his/her fists, this may display his/her stress or anger. Alternatively, if the human object wrings his/her hands, this may indicate nervousness or anxiety. In an embodiment, the image processor 608 may utilize one or more image tracking techniques to track the hand motions. Based on the tracking of the hand motions, the image processor 608 may determine the state of the hands of the human object in the video content.

### Body Motions of the Human Object

In an embodiment, the image processor 608 may analyze the body motions of the human object to determine a body posture of the human object. The body posture of the human object may be useful to determine the body language of the human object. For example, if the human object sits/stands upright and keeps his/her hands/feet apart, this may be indicative of an open body posture. In such a scenario, the body language of the human object may be associated with qualities such as friendliness, openness, and willingness. Further, if the human object hunches forward and keeps his/her hands/feet crossed, this may be indicative of a closed body posture. In such a scenario, the body language of the human object may be associated with qualities such as unfriendliness, hostility, and anxiety.

### Facial Expressions/Emotions of the Human Object

In an embodiment, the image processor 608 may use one or more facial detection and/or pattern recognition techniques to determine facial expressions/emotions of the human object from the set of frames in the video content. The facial expressions/emotions of the human object may be used to determine the information pertaining to the body language of the human object. For example, if the human object has a happy facial expression and smiles frequently while speaking, this may be indicative of the body language of the human object being associated with qualities such as openness and willingness. However, if the human object has an indifferent look on his/her face and does not smile much, this may be indicative of the body language of the human object being associated with qualities such as anxiety, lack of confidence, or disinterest.

### Proximity of the Human Object to a Video Capturing Device

A person skilled in the art will understand that during a creation of the video content, a video footage of the human object may be captured using a video capturing device (e.g., a camera/video recorder). The human object may look towards the video capturing device and may be at a certain distance from the video capturing device during the recording of the video footage. In an embodiment, the image processor 608 may determine this distance of the human object from the video capturing device using the one or more facial detection and/or pattern recognition techniques. For instance, after the recording of the video footage, the video capturing device may embed information pertaining lens configuration of the video capturing device within the video content. The information pertaining to the lens configuration may include, but is not limited to, a focal length of the lens, an aperture of the lens, and an exposure of the lens. In an embodiment, the image processor 608 may detect the human object in the video footage within the video content using the one or more facial detection and/or pattern recognition techniques. Thereafter, the image processor 608 may use the information pertaining to the lens configuration to determine the distance of the human object from the video capturing device.

After determining the distance of the human object from the video capturing device, the image processor 608 may determine a degree of proximity of the human object from the video capturing device. For instance, the image processor 608 may determine that the human object is proximate to the video capturing device if the human object stays within a predefined distance from the video capture device. A close proximity of the human object to the video capturing device may be indicative of the body language of the human object being open, friendly, and expressive. Further, this may also portray qualities of confidence and self-assurance in the human object's body language. On the contrary, a lesser proximity from the video capturing device may be indicative of the body language of the human object being aloof, shy, nervous, or anxious.

### Eye Contact of the Human Object Towards the Video Capturing Device

Using the one or more facial detection and/or pattern recognition techniques to analyze the video footage, the image processor 608 may determine a degree of eye contact of the human object towards the video capturing device. For example, the human object looks away frequently or does not have sufficient eye contact towards the video capturing device, while facing the video capturing device. This may be indicative of the body language of the human object having qualities such as lack of confidence, evasiveness, nervousness, camera consciousness, or anxiety. However, if the human object looks directly into the video capturing device and maintains eye contact, this may indicate the human object's body language exhibiting confidence, openness, self-assurance, and sincerity.

A person skilled in the art will understand that the scope of the disclosure should not be limited to determining the body language information based on the aforementioned factors and using the aforementioned techniques. Further, the examples provided in supra are for illustrative purposes and should not be construed to limit the scope of the disclosure.

In addition of determining the body language information from the video content (extracted from the video content), the image processor 608 is further configured to determine if the video content comprise an inanimate object. In an embodiment, the inanimate object may correspond to an object with which a human object may interact in the video content. For example, the inanimate object may be white board that is used by the human object to explain the first concept and the second concept, in the video content. Further, the inanimate object may be a news board or a large screen with which the human object is interacting in the video content. A person having ordinary skill in the art would understand that the scope of the disclosure is not limited to the above mentioned inanimate objects. In an embodiment, the inanimate object may correspond to any object with which the human object is interacting with in the video content.

After determining if the video content includes an inanimate object, the image processor 608 may determine a type of interaction of the human object with the inanimate object. Some examples of the type of interactions include, but are not limited to, the human object writing on the inanimate object, the human object pointing towards or touching the inanimate object, the human object holding the inanimate object, the human object scrolling through a textual content on the inanimate object, or the human object modifying/highlighting the textual content on the inanimate object.

### The Human Object Writing on the Inanimate Object

In an embodiment, the image processor 608 may analyze the set of frames to detect the inanimate object and the human object, using the one or more image processing techniques (e.g., one or more facial detection/pattern detection techniques). Thereafter, the image processor 608 may detect when the human object writes or scribbles on the inanimate object. For instance, the image processor 608 may perform a frame subtraction between consecutive frames or a consecutive group of frames from the set of frames to determine a change in the textual content on the inanimate object. Further, the image processor 608 may determine if the human object caused the change in the textual content (e.g., by writing/scribbling) on the inanimate object, the image processor 608 may determine whether and how frequently the human object wrote/scribbled on the inanimate object.

### The Human Object Pointing Towards or Touching the Inanimate Object

In an embodiment, the image processor 608 may analyze the set of frames to detect the inanimate object and the human object, using the one or more facial detection/pattern detection techniques, as discussed in supra. Thereafter, the image processor 608 may use one or more image processing techniques (e.g., one or more contour detection techniques, one or more edge detection techniques, one or more ridge detection techniques, and so on) to determine whether the human object points towards or touches the inanimate object in a particular frame. Thereafter, the image processor 608 determines a count of frames in which the human object points towards or touches the inanimate object.

### The Human Object Holding the Inanimate Object

In an embodiment, the image processor 608 may determine a count of frames in which the human object holds the inanimate object, in a manner similar to that described in supra (in reference to description of the human object pointing towards or touching the inanimate object).

### The Human Object Scrolling Through a Textual Content on the Inanimate Object

In an embodiment, the image processor 608 may analyze the set of frames to detect the inanimate object and the human object, using the one or more facial detection/pattern detection techniques, as discussed in supra. Thereafter, the image processor 608 may use one or more image processing techniques to determine a group of frames from the set of frames, in which the human object makes a hand movement, points towards or touches the inanimate object, or makes any other action such that in succeeding frames, the textual content on the inanimate object is scrolled. Such group of frames may capture the action of the human object scrolling through the textual content on the inanimate object. In an embodiment, the image processor 608 may determine a count of such group of frames in which the human object scrolled through the textual content.

In an alternate embodiment, in a scenario where the inanimate object includes a presentation slide, the video content may include information pertaining to change of slides initiated by the human object. For instance, the presentation slide may correspond to a Microsoft® Powerpoint™ Presentation (PPT) slide stored in a .PPTX format. In such a scenario, when the presentation slide is presented by the human object during a recording of the video content of the human object by the video capturing device, slide change events (e.g., scrolling of textual contents) may be captured and stored within the .PPTX file as an XML (eXtensible Markup Language) content. This XML content stored within the .PPTX file may be including within the multimedia content in a scenario where the .PPTX file is also a part of the multimedia content. In an embodiment, the image processor 608 may use the processor 208 to analyze the XML content and thereafter determine the action of the human object scrolling of the textual content in the presentation slide.

### The Human Object Modifying/Highlighting the Textual Content on the Inanimate Object

In an embodiment, the image processor 608 may determine whether and how frequently the human object modifies/highlights the textual content on the inanimate object, in a manner similar to that described in supra (in reference to description of the human object writing on the inanimate object).

In a scenario, where the one or more frames of the video content includes textual content, the image processor 608 may convert the image of the textual content to editable textual content using one or more OCR, ICR techniques. Further, the image processor 608 may send the textual content extracted from the one or more image frames as the first text to the text processor 612.

A person skilled in the art will understand that the scope of the disclosure should not be limited to determining the interaction information based on the aforementioned factors and using the aforementioned techniques. Further, the examples provided in supra are for illustrative purposes and should not be construed to limit the scope of the disclosure.

After extracting the body language information and the interaction information, the image processor 608 is configured to store the body language information and the interaction information in the second memory 604 as the one or more features.

Concurrently, the digital signal processor 610 is configured to analyze the audio content extracted from the segment of the first content to determine one or more audio features. In an embodiment, the one or more audio features may include, but are not limited to, speech rate, an accent, a speaking style, a background audio, and a background noise. In an embodiment, the digital signal processor 610 may utilize one or more digital signal processing techniques to determine the one or more audio features. Thereafter, the digital signal processor 610 may store the one or more audio features in the second memory 604 as the one or more features.

In an embodiment, the digital signal processor 610 is further configured to perform speech to text operation on the audio content to obtain second text. Further, the digital signal processor 610 may send the second text to the text processor 612.

The text processor 612 is configured to receive the first text and the second text from the image processor 608 and the digital signal processor 610, respectively. The text processor 612 may analyze the first text and the second text to determine the first concept being described in the segment of the first content. In an embodiment, the text processor 612 may utilize POS tagger to determine the first concept. Further, in an embodiment, the text processor 612 is configured to determine sentiments from the first text and the second text. In an embodiment, the text processor 612 may utilize techniques disclosed in the U.S. patent application Ser. No. 14/624,925; filed Feb. 18, 2015; “Methods And Systems For Predicting Psychological Types;” Prince Gerald Albert, et al; assigned to Xerox and herein incorporated by reference in its entirety. However, scope of the disclosure is not limited to techniques described in the above mentioned patent application. In an embodiment, the text processor 612 may utilize any known technique to determine the sentiments from the first text and the second text. Thereafter, the text processor 612 may store the sentiments and the first concept in the second memory 614 as the one or more features.

In addition, the text processor 612 is further configured to extract one or more first keywords and one or more second keywords from the first text and the second text, respectively. In an embodiment, the one or more first keywords and the one or more second keywords may corresponds to action verbs. The text processor 612 may store the one or more first keywords and the one or more second keywords as the one or more features.

In a scenario, where the segment of the first content corresponds to the text content, the second processor 602 may similarly determine the one or more features as described supra for the multimedia content. However, the person having ordinary skill in the art would understand that since the text content does not include any audio content or a video content, therefore, for the text content, the text processor 612 may be utilized for determining the one or more features. Further, the one or more features associated with the text content may be similar to the one or more features determined from the first text and the second text (i.e., sentiments and the first concept).

After determining the one or more features, the second processor 602 may utilize the one or more features to formulate one or more search strings. In an embodiment, the second processor 602 may concatenate the one or more features to formulate the search strings. In an embodiment, the one or more search strings are created based the combination of the one or more features. For example, following table illustrates one or more features extracted from the segment of the first content:

TABLE 1
one or more features extracted from the segment of the first content.

| | | Body | Inanimate | Interaction |
|---|---|---|---|---|
| Sentiment | Concept | language | object | type |
| Extrovert | Data | Relaxed | White board | Writing on |
| | encapsulation | | | White board |

The second processor 602 may create one or more following search strings based on the one or more features mentioned in the Table 1:

(Data encapsulation+relaxed+extrovert+white board+writing) (1)

(Data encapsulation+relaxed) (2)

(Data encapsulation white board+writing) (3)

In an embodiment, the second processor 602 may query the content repository database 106 using the one or more search strings to extract one or more second content items. A person having ordinary skill in the art would understand that in order extract the one or more second content from the content repository database 106, the content repository database 106 is the content items pre-indexed on the one or more features.

In response to the one or more search strings, the second processor 602 may receive the one or more second content items from the content repository database 106. Thereafter, the second processor 602 may categorize the one or more second content items in one or more categories, wherein each of the one or more categories represents a feature from the one or more features. In an embodiment, the second processor 602 may categorize the one or more second content items based on the one or more features associated with each of the one or more second content items. For example, the one or more features include an “extrovert” personality type and “whiteboard” inanimate object. The one or more categories will include a first category (representing extrovert category type) and a second category (representing whiteboard). The first category may include second content items in which the presenter exhibits an extrovert personality type. Similarly, the second category may include the second items in which there is a whiteboard.

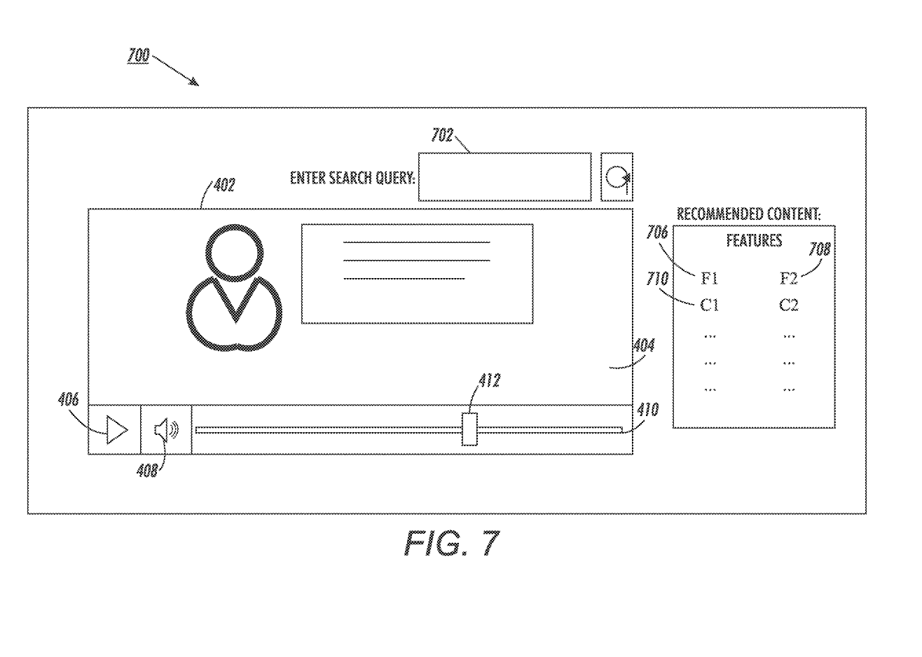

In an embodiment, the second processor 602 is configured to send the one or more second content to the user-computing device 102 as recommendations. In an embodiment, the user-computing device 102 may display the one or more second content based on the categorization. An example user interface has been described later in conjunction with FIG. 7.

FIG. 7 illustrates a snapshot of a user interface 700 illustrating recommendation of the one or more second content items, in accordance with at least one embodiment.

The user interface 700 includes a portion that displays the content player 402. The content player 402 presents the first content to the user of the user-computing device. The user interface 700 comprises a search bar 702 that enables the user to input the search query. As discussed, the search query is used by the content server 104 to search for the first content in the content repository database 106. Further, the user interface 700 includes a portion 704 that used to display recommendation to the user on the user-computing device 102. In an embodiment, the portion 704 displays one or more features of the segment of the first content accessed by the user during the presentation of the first content in the content player 402. For example, the one or more features include a feature F1 (depicted by 706) and feature F2 (depicted by 708). Under each of the one or more features displayed in the portion 704, the set of second content is displayed. As discussed, the content in the set of second content has same/similar features as that of the feature under which it is being displayed in the portion 704. For example, the content C1 (depicted by 710) is displayed under the feature F1 (depicted by 706) has the feature F1. For example, if the feature F1 (depicted by 706) corresponds to introvert sentiment feature. The content C1 (depicted by 710) will include a presenter that displays introvert nature. Similarly, all the set of second content under the introvert sentiment feature will have a presenter that presents the introvert nature.

A person having ordinary skill in the art would understand that the scope of the disclosure is not limited to the user interface 700. In a scenario, where a software application is used for text content, the one or more recommendations is displayed to the user as pop-ups or in the portions where the text content is not being displayed.

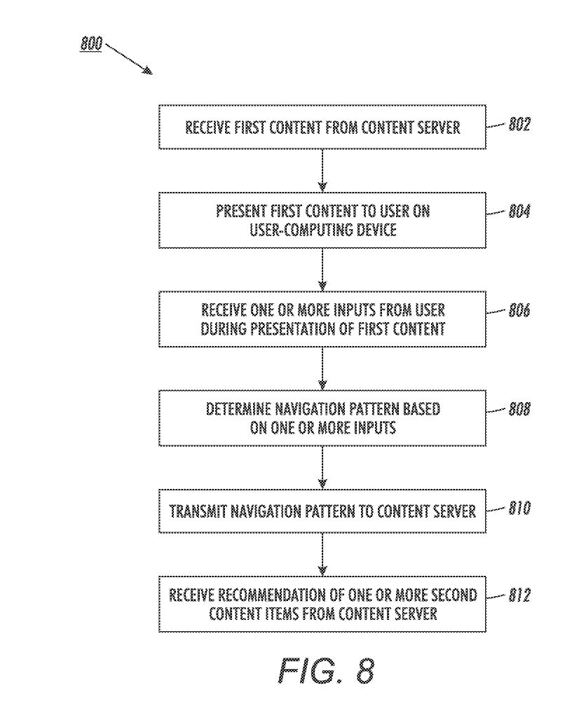

FIG. 8 is a flowchart 800 illustrating a method for determining a navigation pattern of a user, in accordance with at least one embodiment. The flowchart 800 has been described in conjunction with FIG. 3.

At step 802, a first content is received from the content server 104. In an embodiment, the first processor 302 receives the first content from the content server 104.

At step 804, the first content is presented to the user of the user-computing device 102. In an embodiment, the first processor 302 is configured to present the first content. As discussed, the first processor 302 may invoke a software application (such as a content player) to present the content.

At step 806, one or more inputs from the user are received. In an embodiment, the first processor 302 is configured to receive the one or more inputs. As discussed above, the one or more inputs may correspond to navigating through the segment of the first content, during the presentation if the first content.

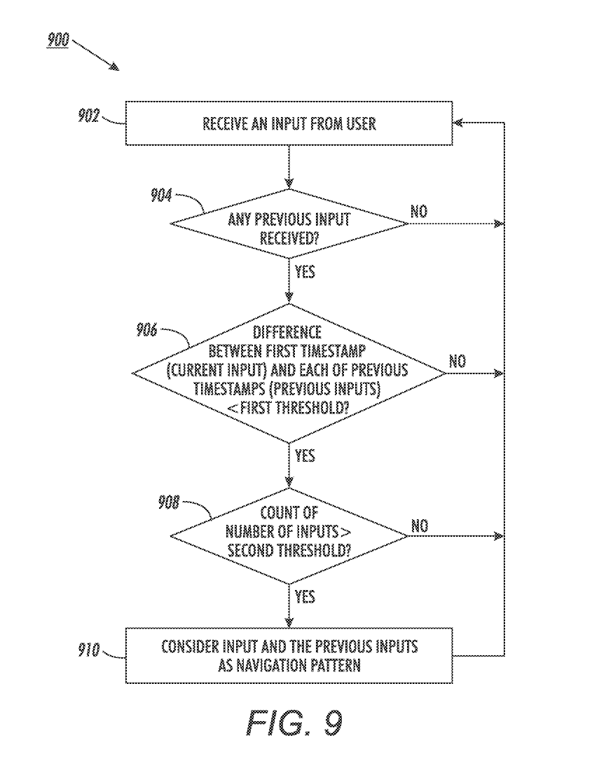

At step 808, the navigation pattern is determined. In an embodiment, the first processor 302 is configured to determine the navigation pattern. The determination of the navigation pattern has been discussed later in conjunction with FIG. 9.

At step 810, the navigation pattern is transmitted to the content server 104. In an embodiment, the first processor 302 is configured to send the navigation pattern to the content server 104 through the first transceiver 306 over the network 110.

At step 812, a recommendation of one or more second items is received. In an embodiment, the recommendation is received from content server 104. In an embodiment, the one or more second content items are displayed on the display device of the user-computing device 102.

FIG. 9 is flowchart 900 illustrating a method for determining a navigation pattern based on one or more inputs received from the user of the user-computing device 102, in accordance with at least one embodiment.

At step 902, an input is received from a user. In an embodiment, the first processor 302 is configured to receive the input from the user through the input devices 310. In an embodiment, the input corresponds movement of the seek bar for current playback position to an approximate playback position of the segment of the first content. In an embodiment, the first processor 302 is further configured to determine a first timestamp associated with the position to which the seek bar was moved.

At step 904, a check is performed to determine whether any other input pertaining to movement of the seek bar was received. In an embodiment, the first processor 302 is configured to perform the check. In an embodiment, if it is determined that no previous inputs were received, the first processor 302 repeats the step 902. If the first processor 302 determines that previous inputs pertaining to the movement of the seek bar was received, the first processor 302 performs the step 906.

At step 906, a check if performed to determine if the difference between each of the previous timestamps and the first timestamp is less than the first threshold value. In an embodiment, the first processor 302 performs the check. In an embodiment, if the first processor 302 determines that the difference is less the first threshold values, the first processor 302 increase the count of number of inputs received from the user and performs the step 908. If the first processor 302 determines that difference if not less than the first threshold value, the first processor 302 repeats the step 902.

At step 908, another check is performed to determine if the count of number of inputs received from the user is greater than a second threshold value. In an embodiment, the first processor 302 performs the check. In an embodiment, if the first processor 302 determines that the count of the number of inputs received from the user is greater than the second threshold value, the step 910 is performed. If the first processor 302 determines that, the count of the number of inputs is less than the second threshold, the first processor 302 repeat the step 902.

At step 910 the inputs received from the user are considered as the navigation pattern. In an embodiment, the first processor 302 considers the inputs received from the user as the navigation pattern.

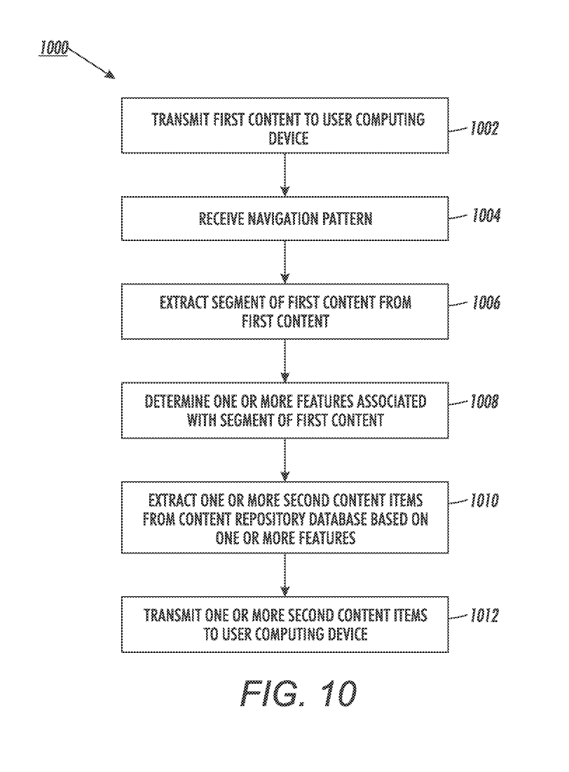

FIG. 10 is a flowchart 1000 illustrating a method for recommending one or more second content, in accordance with at least one embodiment. The flowchart 900 is described in conjunction with FIG. 1, FIG. 3, and FIG. 6.

At step 1002, the first content is transmitted to the user-computing device 102. In an embodiment, the second processor 602 is configured to transmit the first content to the user-computing device 102.

At step 1004, the navigation pattern is received. In an embodiment, the second processor 602 is configured to receive the navigation pattern.

At step 1006, the segment of the first content is extracted from the first content. In an embodiment, the second processor 602 is configured to extract the segment of the first content from the first content based on the navigation pattern.

At step 1008, the one or more features associated with segment of the first content is determined. In an embodiment, the second processor 602 is configured to determine the one or more features.

At step 1010, the one or more second content items are extracted from the content repository database 106 based on the one or more features. In an embodiment, the second processor 602 may utilize the one or more features to formulate the one or more search strings. The one or more search strings are used for querying the content repository to extract the one or more second content items.

At step 1012, the one or more second content items are transmitted to the user-computing device 102 as recommendation. In an embodiment, the second processor 602 is configured to transmit the one or more second content items.

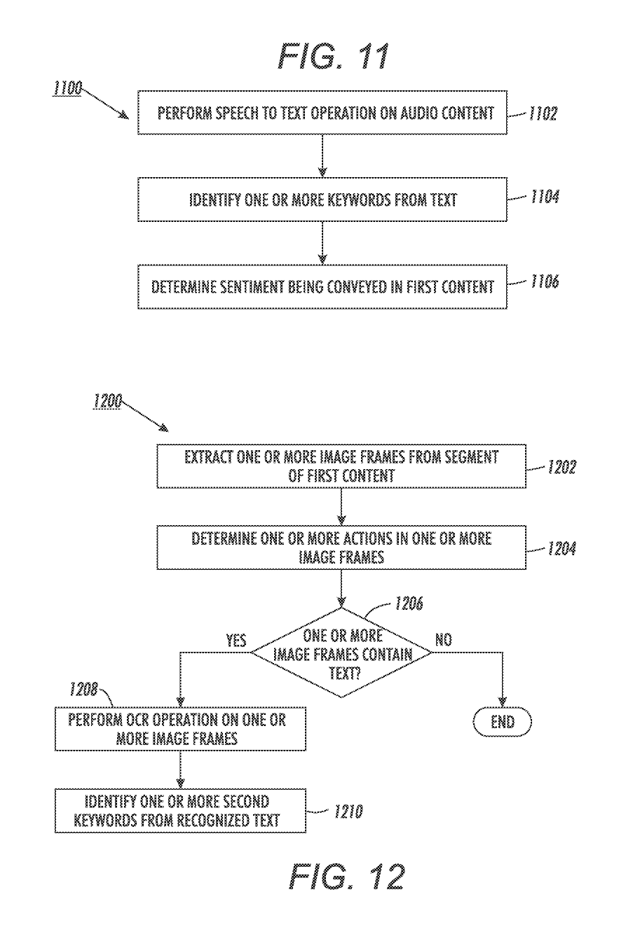

FIG. 11 is a flowchart 1000 illustrating a method for determining one or more features, in accordance with at least one embodiment. The flowchart 1000 is described in conjunction with FIG. 6.

At step 1102, speech to text operation is performed on the audio content. In an embodiment, the digital signal processor 610 is configured to determine perform the speech to text operation. In an embodiment, the audio content may extracted from the multimedia content (i.e., first content). In an alternate embodiment, the first content itself may correspond to the audio content.

At step 1104, one or more keywords are extracted from the text (obtained in step 1002). In an embodiment, the text processor 612 is configured to determine the one or more keywords.

At step 1106, a sentiment being conveyed in the segment of the first content is determined. In an embodiment, the text processor 612 is configured to determine the sentiment.

FIG. 12 is a flowchart 1200 illustrating a method for determining one or more features from the segment of the first content, in accordance with at least one embodiment. The flowchart 1100 is described in conjunction with FIG. 6.

At step 1202, one or more image frames are extracted from the segment of the first content. In an embodiment, the image processor 608 is configured to extract the one or more image frames from the first content. A person having ordinary skill in the art would understand the one or more image frames may be extracted from the first content only if the first content corresponds to multimedia content.

At step 1204, one or more action performed by one or more objects are determined. In an embodiment, the image processor 608 is configured to determine the one or more actions. In an embodiment, the image processor 608 may utilize one or more image processing techniques to determine the one or more actions being performed in the first content.

At step 1206, a check is performed to determine if the one or more image frames include the text content. In an embodiment, the image processor 608 is configured to perform the check. In an embodiment, if the image processor 608 determines that the one or more image frames comprise text content, step 11087 is performed.

At step 1208, OCR operation is performed on the one or more image frames. In an embodiment, the image processor 608 is configured to perform the OCR operation to recognize text in the one or more image frames.

At step 1210, one or more second keywords are determined from the recognized text. In an embodiment, the text processor 612 is configured to determine the one or more keywords. After determining the one or more keywords, the step 1006 is performed again.

The disclosed embodiments encompass numerous advantages. As only the segment of the content (being viewed by the user frequently) is analyzed to determine the one or more features, the recommendation to the user is much more accurate and relevant to the user in comparison to traditional techniques.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for recommending content have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for content processing, by a content server, to provide recommendation of content items, the method comprising:
receiving, by a transceiver in the content server, a navigation pattern, corresponding to an input provided by a user, from a user computing device over a communication network for a first content presented on the user computing device, wherein a difference between each of one or more previous timestamps associated with one or more previous inputs and a first timestamp associated with the input is less than a first threshold value, wherein a count of number of inputs, including the received input and one or more previous inputs, provided by the user is greater than a second threshold value;
extracting, by one or more processors in the content server, a segment of the first content based on a starting timestamp and an ending timestamp of the received navigation pattern modified using a predetermined time duration;
determining, by the one or more processors, one or more features of the extracted segment of the first content being accessed during a presentation of the first content on the user-computing device;
extracting, by the one or more processors, one or more second content relevant to the user based on the determined one or more features of the extracted segment; and
transmitting, by the transceiver, the extracted one or more second content relevant to the user to the user computing device over the communication network.

2. The method of claim 1 further comprising receiving, by the one or more processors, one or more of a timestamp or a time interval associated with the segment of the first content from the user-computing device.

3. The method of claim 2 further comprising extracting, by the one or more processors, the segment of the first content from the first content based on the one or more of the timestamp or the time interval associated with the segment of the first content.

4. The method of claim 1 further comprising converting, by the one or more processors, an audio content of the segment of the first content to a first text using one or more speech to text conversion techniques.

5. The method of claim 4 further comprising identifying, by the one or more processors, one or more first keywords from the first text using one or more natural language processing techniques, wherein the one or more first keywords are included in the one or more features of the segment of the first content.

6. The method of claim 5 further comprising determining, by the one or more processors, a sentiment, being conveyed in the segment of the first content, from the first text using one or more sentiment detection techniques, wherein the sentiment is included in the one or more features of the segment of the first content.

7. The method of claim 1 further comprising extracting, by the one or more processors, a second text from one or more image frames of the segment of the first content using one or more optical character recognition (OCR) techniques.

8. The method of claim 7 further comprising identifying, by the one or more processors, one or more second keywords from the second text using one or more natural language processing techniques, wherein the one or more second keywords are included in the one or more features of the segment of the first content.

9. The method of claim 7 further comprising tracking, by the one or more processors, a movement of one or more objects in the one or more image frames to determine one or more actions being performed by the one or more objects in the one or more image frames, wherein the one or more actions are included in the one or more features of the segment of the first content.

10. A system for content processing, by a content server, to provide recommendation of content items, the system comprising:
a transceiver in the content server configured to:
receive a navigation pattern, corresponding to an input provided by a user, from a user computing device over a communication network for a first content presented on the user computing device, wherein a difference between each of one or more previous timestamps associated with one or more previous inputs and a first timestamp associated with the input is less than a first threshold value, wherein a count of number of inputs, including the received input and one or more previous inputs, provided by the user is greater than a second threshold value;
one or more processors in the content server configured to:
extract a segment of the first content based on a starting timestamp and an ending timestamp of the received navigation pattern modified using a predetermined time duration;
determine one or more features of the extracted segment of the first content being accessed during a presentation of the first content on the user-computing device;
extract one or more second content relevant to the user based on the determined one or more features of the extracted segment; and
the transceiver in the content server further configured to:
transmit the extracted one or more second content relevant to the user to the user computing device over the communication network.

11. The system of claim 10, wherein the first content is presented on the user-computing device through a software application, wherein a type of software application invoked depends on a type of first content, and wherein the type of the first content comprises a multimedia content and a text content.

12. The system of claim 11, wherein, when the first content corresponds to the multimedia content, the software application comprises a seek bar representative of a playback axis of the first content, wherein the user-computing device receives an input to select one or more of a timestamp or a time interval to access the segment of the first content through the seek bar.

13. The system of claim 12, wherein the one or more processors are further configured to receive one or more of the timestamp or the time interval associated with the segment of the first content from the user-computing device.

14. The system of claim 13, wherein the one or more processors are further configured to extract the segment of the first content from the first content based on the one or more of the timestamp or the time interval.

15. The system of claim 14 further comprising a digital signal processor configured to convert an audio content of the segment of the first content to a first text using one or more speech to text conversion techniques.

16. The system of claim 15 further comprising a text processor configured to identify one or more first keywords from the first text using one or more natural language processing techniques, wherein the one or more first keywords are included in the one or more features of the segment of the first content.

17. The system of claim 10 further comprising an image processor configured to extract a second text from one or more image frames, of the segment of the first content, using one or more optical character recognition (OCR) techniques.

18. The system of claim 17 further comprising a text processor configured to identify one or more second keywords from the second text using one or more natural language processing techniques, wherein the one or more second keywords are included in the one or more features of the segment of the first content.

19. A computer program product for use with a computer, the computer program product comprising a non-transitory computer readable medium, wherein the non-transitory computer readable medium stores a computer program code for content processing to provide recommendation of content items, wherein the computer program code is executable by one or more processors in a content server to:
receive a navigation pattern, corresponding to an input provided by a user, from a user computing device over a communication network for a first content presented on the user computing device, wherein a difference between each of one or more previous timestamps associated with one or more previous inputs and a first timestamp associated with the input is less than a first threshold value, wherein a count of number of inputs, including the received input and one or more previous inputs, provided by the user is greater than a second threshold value;
extract a segment of the first content based on a starting timestamp and an ending timestamp of the received navigation pattern modified using a predetermined time duration;
determine the one or more features of the extracted segment of the first content being accessed during a presentation of the first content on the user-computing device;
extract one or more second content relevant to the user based on the determined one or more features of the extracted segment; and
transmit the extracted one or more second content relevant to the user to the user computing device over the communication network.

20. The method of claim 1, wherein the received navigation pattern is representative of one or more actions performed by the user while presentation of the first content on the user-computing device, wherein the one or more actions include at least navigating to watch a specific segment of the first content, highlighting a portion of the first content, searching for a phrase in the first content, searching for a phrase using a search engine, and watching another content related to concept discussed in the first content.
